(19) United States
(12) Patent Application Publication
(10) Pub. No.: US 2015/0208706 A1
(43) Pub. Date: Jul. 30, 2015

(54) POWDERED NUTRITIONAL COMPOSITIONS COMPRISING A DRYBLENDED NEAT CEREAL BETA-GLUCAN AND RESISTANT STARCH

(71) Applicant: ABBOTT LABORATORIES, Abbott Park, IL (US)

(72) Inventors: Gaurav Patel, Gahanna, OH (US); Isabela Balassiano Hahn, Singapore (SG); Ai-Mey Chuah, Singapore (SG); Chea Yun Se, Singapore (SG)

(73) Assignee: ABBOTT LABORATORIES, Abbott Park, IL (US)

(21) Appl. No.: 14/421,100

(22) PCT Filed: Aug. 13, 2013
(86) PCT No.: PCT/US2013/054730

§ 371 Date: Feb. 11, 2015

Related U.S. Application Data
(60) Provisional application No. 61/682,901, filed on Aug. 14, 2012.

(51) Int. Cl. A23L 1/29; A23L 1/30

(52) U.S. Cl. CPC A23L 1/293; A23L 1/3002; A23V 2002/00

(57) ABSTRACT

Disclosed are nutritional compositions comprising a dryblended mixture of a neat cereal beta-glucan and a resistant starch. The dryblending of the neat cereal beta-glucan and the resistant starch improves the cold water solubility of the nutritional compositions. The dryblended nutritional compositions may further include a Salacia extract.

### CROSS-REFERENCE TO RELATED APPLICATION

This application claims the benefit of and priority to U.S. Provisional Patent Application Ser. No. 61/682,901, entitled POWDERED NUTRITIONAL COMPOSITIONS COMPRISING A DRYBLENDED NEAT CEREAL BETA-GLUCAN AND RESISTANT STARCH and filed Aug. 14, 2012, the entire disclosure of which is incorporated herein by reference, to the extent that it is not conflicting with the present application.

### TECHNICAL FIELD

The present disclosure relates to water soluble nutritional compositions comprising at least two dryblended components. More specifically, the present disclosure is directed to cold water soluble/dispersible nutritional compositions including a neat cereal beta-glucan and a resistant starch that have been dryblended together for use in combination with a Salacia extract.

### BACKGROUND OF THE DISCLOSURE

Diabetes mellitus is a disorder of carbohydrate metabolism resulting from insufficient production of, or reduced sensitivity to, insulin. In persons who have diabetes, the normal ability of the body to utilize glucose is compromised, thereby increasing blood glucose levels. As more glucose accumulates in the blood, excess levels of glucose are excreted in the urine. Corresponding symptoms of diabetes include increased urinary volume and frequency, thirst, hunger, weight loss, and weakness.

Diabetes is often characterized as either type 1 or type 2. Among the earliest manifestations of type 2 diabetes includes excessive blood glucose levels following a meal due to inadequate first phase insulin secretion. In these individuals, the response to increased blood glucose levels and the modulation of such levels that would otherwise occur in a healthy individual is reduced or absent and thus results in an excessive spike in postprandial blood glucose levels. This is particularly significant given the well established correlation between effective blood glucose control in a diabetic individual and the risk of developing cardiovascular or circulatory diseases or disorders, especially the microvacsular and macrovascular complications from such diseases or disorders. As such, controlling postprandial blood glucose levels in the diabetic individual is an important step in reducing the development of cardiovascular or circulatory diseases, and of course the subsequent development of cardiovascular related conditions such as retinopathy, neuropathy, nephropathy, and so forth.

Postprandial glucose levels may be controlled and regulated in prediabetic individuals and individuals with diabetes, and particularly type 2 diabetes, by administering to the individual a nutritional composition comprising a cereal beta-glucan, or a 1-3,1-4-β-D-linked beta-glucan, in combination with a Salacia extract. When combined in a nutritional composition, the beta-glucan and Salacia extract act synergistically to control and regulate the postprandial glucose levels in an individual such that the absorption of glucose into the bloodstream is retarded and slowed over time. This combination may allow for a reduction in the amount of both ingredients in the nutritional composition and an associated cost savings.

While the nutritional composition comprising the combination of a cereal beta-glucan and a Salacia extract has been shown to reduce post-prandial glucose levels, it has further been found that at least the cereal beta-glucan component in the composition may have poor solubility and exhibit poor dispersibility, wettability, and mixability in cold water, making this composition poorly suited for use in ready to drink powder form and clumping may occur. To date, efforts to reduce and/or eliminate this undesirable clumping have had limited success.

There is therefore a need for water soluble and/or water dispersible nutritional compositions including cereal beta-glucans, as well as methods of improving the cold water solubility, wetting properties, and dispersibility/mixability of a powdered nutritional composition including a cereal beta-glucan.

### SUMMARY OF THE DISCLOSURE

The present disclosure is directed to nutritional compositions that include a neat cereal beta-glucan and a resistant starch. The nutritional compositions are at least partially dryblended nutritional compositions wherein at least a portion, or all, of the neat cereal beta-glucan and resistant starch are in dryblended form. These nutritional compositions will also typically include a Salacia extract that may or may not be dryblended with the neat cereal beta-glucan and resistant starch, and the resistant starch may optionally be in agglomerated form. By dryblending at least a portion of the neat cereal beta-glucan and the resistant starch, the solubility, including the cold water solubility, of the nutritional composition is significantly improved such that the amount of clumping is reduced and the dispersibility and wettability of the nutritional composition is improved to enhance the commercial desirably of the nutritional composition. In many embodiments, the neat cereal beta-glucan is a barley beta-glucan and the resistant starch is a wheat-derived resistant starch.

The present disclosure is directed to a powdered nutritional composition comprising a dryblended mixture of a neat cereal beta-glucan and a resistant starch.

The present disclosure is further directed to a powdered nutritional composition including 100% by weight dryblended components. The dryblended components include a neat cereal beta-glucan, a resistant starch, a Salacia extract and fructooligosaccharides.

The present disclosure is further directed to a method of improving the cold water solubility of a powdered nutritional composition comprising a neat cereal beta-glucan. The method comprises dryblending the cereal beta-glucan with a resistant starch.

It has been unexpectedly found that when a neat cereal beta-glucan, such as a barley beta-glucan, is dryblended with a resistant starch, such as a wheat-derived resistant starch, the water solubility, and specifically the cold water solubility, of the nutritional composition is enhanced, even in the presence of a Salacia extract. Through dryblending at least a portion of these components, the wettability and dispersibility of the nutritional composition is also improved such that the composition is more commercially acceptable. In some embodiments, the cold water solubility, wettability and dispersibility of the nutritional composition may be further improved if the resistant starch is dryblended into the nutritional composition with the neat beta-glucan in agglomerated form.

Accordingly, the nutritional compositions and methods of the present disclosure provide nutritional compositions that are highly soluble in cold water and may, in some embodiments, be able to offer a natural therapeutic option that may contribute to the maintenance of optimal glycemic control in subjects that are prediabetic, have impaired glucose tolerance, or have type 2 diabetes. These benefits are advantageously achieved in such individuals without experiencing many of the complications often associated with the administration of oral anti diabetic medications.

### DETAILED DESCRIPTION OF THE DISCLOSURE

The present disclosure provides water-soluble nutritional compositions, and methods of using the nutritional compositions, for addressing, controlling and managing diabetes in an individual. The disclosed nutritional compositions, in addition to a Salacia extract, include a neat cereal beta-glucan and a resistant starch that have been dryblended together during the manufacturing process to produce a dryblended nutritional composition. Through dryblending of these components, the wettability and dispersibility of the nutritional composition is enhanced such that the composition is more commercially attractive. This may be particularly advantageous in cold water applications, as the dryblended nutritional compositions also disperse well and avoid clumping in cold water. This provides an easy and convenient means for an individual to utilize the nutritional composition by dissolving it into a drink, including a cold drink, for consumption by itself, or advantageously with a meal to allow the benefits of the Salacia extract to be obtained. Alternatively, the nutritional compositions as described herein may be sprinkled over food or a meal to assist in the management of diabetes and its related symptoms and conditions.

In many embodiments, the present disclosure uses a neat barley beta-glucan that is dryblended with a wheat-derived resistant starch, which may optionally be agglomerated to further improve the solubility characteristics of the nutritional composition. The nutritional compositions may optionally include other ingredients to improve the overall nutritional quality of the composition. These and other elements of the various embodiments are described in detail hereinafter.

The term “nutritional composition” as used herein, unless otherwise specified, means a composition suitable for oral administration to an individual but which does not provide sufficient fat, protein and carbohydrate to form a sole or primary source of nutrition in the individual.

The term “meal” as used herein, unless otherwise specified, means a typical selection of food to be consumed by an individual in one sitting, which most typically includes the food consumed at a breakfast, a lunch, or a dinner and which includes a combination of fat, protein, carbohydrates, vitamins, minerals and water typical of such consumption in one sitting, although it is understood that the term “meal” may also include smaller quantities or even less balanced food combinations taken in the form of snacks between breakfast, lunch and or dinner.

The term “cold water solubility” as used herein, unless otherwise specified, means the solubility of 10 grams of solid (including powderous) nutritional composition in 8 ounces of water at a temperature below room temperature (18° C.-25° C.). In some embodiments, “cold water solubility” may include solubility of the composition of at least 25%, including from 25% to 100%, including from about 50% to 100%, including from about 75% to 100% at a water temperature of 8° C. or even 10° C.

The term “agglomeration” as used herein, unless otherwise specified, means a process where one component is sprayed in liquid form onto a second component in dry form and hot air or similar is used to dry the end product, which is a agglomerated mass. The components may be the same or different components.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified.

All numerical ranges as used herein, whether or not expressly preceded by the term “about”, are intended and understood to be preceded by that term, unless otherwise specified.

The nutritional compositions and methods described herein may also be free of any optional or other ingredient or feature also described herein provided that the remaining compositions or methods still contain the requisite ingredients or features as described herein. In this context, the term “free” means the selected composition or method contains or is directed to less than a functional amount of the ingredient or feature, which most typically is less than 1%, including less than 0.5%, including less than 0.1%, and also including zero percent, by weight of such ingredient or feature.

Any reference to singular characteristics or limitations of the present disclosure shall include the corresponding plural characteristic or limitation, and vice versa, unless otherwise specified or clearly implied to the contrary by the context in which the reference is made.

Any combination of method or process steps as used herein may be performed in any order, unless otherwise specifically or clearly implied to the contrary by the context in which the referenced combination is made.

The nutritional compositions and methods may comprise, consist of, or consist essentially of the elements and features of the disclosure described herein, as well as any additional or optional ingredients, components, or features described herein or otherwise useful in a nutritional application.

### Product Form

The nutritional compositions of the present disclosure include a neat cereal beta-glucan and a resistant starch that have been dryblended together. The nutritional compositions may be formulated in any known or otherwise suitable product form for oral administration, including 100% by weight dryblended nutritional compositions or nutritional compositions that are based on a combination of spray dried powders and dryblended powders/ingredients. The nutritional compositions can be reconstituted with an aqueous liquid such as water, tea or other beverage and ingested, or sprinkled over food or a meal and ingested.

Suitable product forms include dry powders obtained by various techniques such as spray drying, filter-mat drying, drum drying, agglomeration, and/or dry blending, so long as at least a portion of the neat cereal beta-glucan and resistant starch have been dryblended together.

These nutritional composition powder embodiments of the present disclosure, including the embodiments where the nutritional composition is a 100% by weight dryblended powders, may be packaged in any suitable quantity and in any suitable bulk or single serving container (i.e., 100 grams, 200 grams, 300 grams, 400 grams, 500 grams, or more), including a small volume or single serving sachet or other container comprising from 1 to 20 grams, including from 2 to 10 grams, and also including from 4 to 7 grams, of the powder.

The nutritional compositions may be packaged in multi-dose or single serving packages. For the nutritional compositions described herein, a serving represents the amount of the composition to be added to an aqueous liquid or food to achieve the desired blood glucose modulation effect, which liquid or food represents an amount to be reasonably consumed by the individual in one sitting. For the powder embodiment described herein, a single serving of the nutritional composition most typically ranges from about 1 to 20 grams, including from 2 to 10 grams, and also including from 4 to 7 grams.

The nutritional compositions also may contain sufficient ingredients to provide up to about 100 kcal per serving, including from 5 kcal to about 90 kcal per serving, and also including from about 10 kcal to about 70 kcal per serving.

### Neat Cereal Beta-Glucan

The nutritional compositions of the present disclosure include a neat cereal beta-glucan that is at least partially dryblended with the resistant starch as described herein. The term “neat” as used herein, unless otherwise specified, refers to the cereal beta-glucan not be diluted or mixed with another substance prior to incorporating into the nutritional composition. By being in “neat” form, the cereal beta-glucan is not otherwise mixed or co-dried or agglomerated with any other substance prior to the incorporation of the cereal beta-glucan into the nutritional composition.

Any source of the cereal beta-glucan that is known or otherwise suitable for use in an oral nutritional product is also suitable for use herein, provided that such a source is also compatible with, or is otherwise rendered to be compatible with, the other selected ingredients in the composition.

Cereal beta-glucans suitable for use herein are sourced from grains as opposed to, and as distinguished from, yeast and mushroom-derived beta-glucans. Beta-glucans are a class of soluble dietary fibers that are polysaccharides that, when taken with a meal, may result in a slower rate of carbohydrate and lipid absorption. Cereal beta-glucans are linear chains of β-D-glycopyranosyl units (1-3,1-4-β-D-finked as compared to yeast-based beta-glucans that are 1-3,1-6-β-D-finked) in which 70% of the units are typically linked, but which also consist of β-D-cellotriosyl and β-D-cellotetraosyl residues separated by linkages arranged in a random manner. The soluble nature of beta-glucans, in conjunction with their chemical structure, helps to increase the viscosity of foods that contain them.

Suitable cereal-based beta-glucans for use in the nutritional compositions of the present disclosure include oat-derived beta-glucans, barley-derived beta-glucans, and combinations thereof, with barley-derived beta-glucans being especially suitable and desirable. These specific beta-glucans, when combined with the Salacia extract described herein, act synergistically to control and regulate postprandial glucose levels such that glucose absorption into the bloodstream is retarded, thus lengthening the amount of time it takes a given amount of glucose to enter the bloodstream and thus assisting in the management of diabetes and its related symptoms.

The cereal beta-glucan source for use in the nutritional composition may comprise up to 100% by weight of a beta-glucan, including from about 5% to 100%, and also including from about 15% to 100%, and also including from about 50% to 100%, and also including from 50% to 95%, and also including from about 60% to about 85%, beta-glucan by weight of the beta-glucan source.

The cereal beta-glucan selected for use herein may have any weight average molecular weight suitable for the selected use and formulation, but will most typically range from about 50 kDa to about 1000 kDa, including less than about 750 kDa, including from about 100 kDa to about 250 kDa.

One suitable commercially available source of a barley beta-glucan for inclusion in the nutritional composition is Barliv™ (70% barley beta-glucan), commercially available from Cargill (Panora, Iowa).

The nutritional compositions may comprise an amount of cereal beta-glucan sufficient to synergistically interact with the Salacia extract as described herein in providing the desired blood glucose control. The nutritional compositions most typically, however, comprise from about 5% to about 90%, including from about 10% to about 50%, also including from about 11% to about 46%, and also including from about 11% to about 25%, cereal beta-glucan by weight of the nutritional composition. In some embodiments, the nutritional composition may included from about 10% to about 20%, including from about 10% to about 18%, including from about 10% to about 16%, including from about 10% to about 15%, including from about 11% to about 15%, including from about 11% to about 13%, and including about 11% cereal beta-glucan by weight of the nutritional composition.

In some embodiments, the nutritional compositions may include at least about 0.5 grams, including from about 0.5 grams to about 4 grams, also including from about 1.1 grams to about 2.0 grams, and also including from about 0.77 grams to about 1.4 grams, of beta-glucan per serving of the nutritional composition.

### Resistant Starch

The nutritional compositions including the cereal beta-glucan described herein additionally comprise a resistant starch. At least a portion of the cereal beta-glucan described above is dryblended with at least a portion of the resistant starch to form a dryblended nutritional composition.

Any source of a resistant starch that is known or otherwise suitable for use in an oral nutritional product is also suitable for use herein for dryblending with the cereal beta-glucan, provided that such a source is also compatible with, or is otherwise rendered to be compatible with, the other selected ingredients in the nutritional composition.

Suitable resistant starches for use in the nutritional compositions of the present disclosure include wheat-derived resistant starches, corn-derived resistant starches, and combinations thereof, with wheat-derived resistant starches being especially suitable. These specific resistant starches, when dryblended with the cereal beta-glucan described herein, may act to dissolve the fine fibrous structures inherent in the cereal beta-glucan matrices, forming larger particle clusters with visible fracture surfaces. This attachment/dissolution of the cereal beta-glucan by the resistant starch allows for improved cold water solubility, wetting properties, and dispersibility/mixability of the resulting nutritional composition including the cereal beta-glucan.

The resistant starch for dryblending with the cereal beta-glucan of the nutritional composition is typically highly soluble in water, and thus, an aqueous solution of the resistant starch may include up to 80% by weight of a resistant starch, including from about 10% to 80%, and also including from about 20% to 75%, and also including from 25% to 70%, and also including from about 30% to about 65%, resistant starch by weight of the aqueous solution.

One suitable commercially available source of a wheat-derived resistant starch suitable for dryblending with the cereal beta-glucan in the nutritional composition is Nutriose®, as described above and commercially available from Roquette Freres (France), which is a resistant wheat dextrin starch/fiber having extended energy release and typically is used as a sugar substitute.

In some embodiments of the present disclosure, the resistant starch, or a portion of the resistant starch, utilized for dryblending with the cereal beta-glucan may be in agglomerated form to further enhance the wetting properties and dispersion in water of the resistant starch. Suitable agglomeration techniques for agglomerating the resistant starch into a mass for use in the nutritional compositions described herein are known in the art.

### Salacia Extract

The nutritional compositions may, and typically do, comprise a Salacia extract in addition to the dryblended cereal beta glucan and resistant starch. Any source of the Salacia extract that is known or otherwise suitable for use in an oral nutritional product is also suitable for use herein, provided that such a source is also compatible with, or is otherwise rendered to be compatible with, the other selected ingredients in the composition.

The Salacia extract suitable for use herein may include a Salacia oblonga extract and or a Salacia reticula extract, either of which contains at least one of the alpha-glucosidase inhibitors salacinol, kotalanol and mangiferin 9, which have been shown to inhibit the activity of intestinal alpha-glucosidases and mitigate blood glucose responses upon ingestion of food.

Suitable Salacia oblonga extracts for use in the nutritional compositions include both powdered and liquid forms of Salacia oblonga extracts. One specific example of a suitable Salacia oblonga extract is Salacia oblonga Extract A or Salacia oblonga Extract D (both powdered forms), commercially available from Tanabe Seiyaku Company Limited (Osaka Japan).

The nutritional compositions may comprise an amount of Salacia extract sufficient to synergistically interact with the beta-glucan component of the composition in providing the desired blood glucose control. The nutritional compositions most typically, however, include from about 0.5% to about 20%, including from about 0.5% to about 20%, including from about 1% to about 5%, also including from about 1% to about 4%, and also including from about 1% to about 2%, Salacia extract by weight of the nutritional composition.

The nutritional compositions most typically comprise Salacia extract in amounts ranging from at least about 0.05 grams, including from about 0.1 to about 1.0 grams, and also including from about 0.1 grams to about 0.2 grams, and also including from about 0.1 grams to about 0.18 grams, of the extract per serving of the nutritional composition.

The Salacia extract in the nutritional compositions may also be characterized in terms of its alpha-glucosidase inhibitory activity expressed as IC50 (50% inhibitory concentration). The alpha-glucosidase inhibitors in the Salacia extract are salacinol and/or kotalanol. The IC50 inhibitory concentration for the alpha-glucosidases may be from about 50 to about 60 micrograms per milliliter. In one specific example, Salacia oblonga extract D, which has an IC50 of not more than about 50 micrograms per milliliter, can be used in the nutritional compositions.

### Filler Material

The nutritional compositions described herein may further comprise a filler material to augment the bulk properties of the nutritional compositions. These filler materials may include any such material suitably known for or otherwise suitable for use in a nutritional composition.

The filler material may include any nutritional ingredient that adds bulk to the composition, and in most instances will be substantially inert, and does not significantly negate the blood glucose benefits of the nutritional composition. The filler material most typically includes a fiber and or carbohydrate having a low glycemic index, although it is understood that other non-carbohydrate fillers as well as high glycemic index carbohydrate fillers may be used, although less desirably.

The filler material, including any carbohydrate or fiber filler material, may represent enough of the finished product to provide the desired bulk or flow properties, but most typically represents from about 5% to about 90%, including from about 30% to about 90%, including from about 40% to about 85%, also including from about 50% to about 85%, and also including from about 75% to about 80%, by weight of the nutritional composition.

Any carbohydrate source suitable for use in a nutritional composition is also suitable for use as a filler material in the nutritional compositions described herein. Such carbohydrates, however, may advantageously include those having a low glycemic index such as fructose and low DE maltodextrins as such ingredients do not introduce a high glycemic load into the nutritional composition. Other suitable carbohydrate filler material includes any dietary fiber suitable for use in a nutritional product, including soluble and insoluble fiber, especially fructooligosaccharides. The filler material may be selected such that it does not negatively impact the synergistic nature of the beta-glucan and Salacia extract combination described herein.

Non-limiting examples of commercially available filler materials for use herein include, resistant starches, Sunfiber® (Taiyo International, Inc., Minneapolis, Minn.), which is a water-soluble dietary fiber produced by the enzymatic hydrolysis of Guar beans; and Fibersol 2™ (Archer Daniels Midland Company, Bloomington, Ill.), which is a digestion resistant maltodextrin.

### Optional Ingredients

The nutritional composition of the present disclosure may further comprise other optional ingredients that may modify the physical, chemical, aesthetic or processing characteristics of the compositions. Many such optional ingredients are known or otherwise suitable for use in nutritional products and may also be used in the nutritional compositions described herein, provided that such optional ingredients are safe and effective for administration and are compatible with the essential and other selected components in the compositions.

In some embodiments, the nutritional compositions may include a fat source, a protein source, a flowing agent, a stabilizer, a preservative, an anti-oxidant, an acid, a buffer, a pharmaceutical active, a sweetener, an intense sweetener, a colorant, a flavor, a flavor enhancer, an emulsifying agent, an anti-caking agent, a lubricant, and so forth, as well as any combination thereof. Although it is within the scope of the present disclosure for the nutritional composition to include a fat source and/or a protein source, it is generally preferred that the nutritional composition be fat free and/or protein free. When included, the fat and/or protein source may be any conventional fat or protein source suitable for use in powdered nutritional compositions.

A flowing agent or anti-caking agent may be included in the nutritional compositions as described herein to retard clumping or caking of the powder over time and to make a powder embodiment flow easily from its container. Any known flowing or anti-caking agents that are known or otherwise suitable for use in a nutritional powder or product form are suitable for use herein, non-limiting examples of which include tricalcium phosphate, silicates, and combinations thereof. The concentration of the flowing agent or anti-caking agent in the nutritional composition varies depending upon the product form, the other selected ingredients, the desired flow properties, and so forth, but most typically range from about 0.1% to about 4%, including from about 0.5% to about 2%, by weight of the nutritional composition.

A stabilizer may also be included in the nutritional compositions. Any stabilizer that is known or otherwise suitable for use in a nutritional product is also suitable for use herein, some non-limiting examples of which include gums such as xanthan gum. The stabilizer may represent from about 0.1% to about 5.0%, including from about 0.5% to about 3%, including from about 0.7% to about 1.5%, by weight of the nutritional composition.

The nutritional compositions may further comprise minerals suitable for use in a nutritional product, non-limiting examples of which include phosphorus, sodium, chloride, magnesium, manganese, iron, copper, zinc, iodine, calcium, potassium, chromium, chromium picolinate, molybdenum, selenium, and combinations thereof. Chromium picolinate is particularly useful in the nutritional compositions.

The nutritional composition may further comprise any vitamins or similar other materials suitable for use in a nutritional product, some non-limiting examples of which include carotenoids (e.g., beta-carotene, zeaxanthin, lutein, lycopene), biotin, choline, inositol, folic acid, pantothenic acid, vitamin A, thiamine (vitamin B1), riboflavin (vitamin B2), niacin (vitamin B3), pyridoxine (vitamin B6), cyanocobalamin (vitamin B12), ascorbic acid (vitamin C), vitamin D, vitamin E, vitamin K, and various salts, esters or other derivatives thereof, and combinations thereof. Vitamin C, vitamin D, and or vitamin B₁₂ are particularly useful in the nutritional composition.

### Manufacture

The nutritional compositions may be prepared by any known or otherwise effective manufacturing technique for preparing the powder or other selected product form so long as at least a portion of the cereal beta-glucan and resistant starch are dryblended together. Many such techniques are known and may be applied by one of ordinary skill in the art to the nutritional compositions described herein.

In some embodiments, 100% by weight of the total amount of cereal beta-glucan and resistant starch present in the nutritional composition is in dryblended form; that is, in some embodiments, all of the cereal beta-glucan and resistant starch present in the nutritional composition has been dryblended together. In other embodiments, about 90% by weight, or even about 80% by weight, or even about 70% by weight, or even about 60% by weight, or even about 50% by weight, or even about 40% by weight, or even about 30% by weight, or even about 20% by weight, or even about 10% by weight or less of the total amount of cereal beta-glucan and resistant starch present in the nutritional composition is in dryblended form. In accordance with the present disclosure, at least a portion of the cereal beta-glucan and resistant starch are in dryblended form in the nutritional composition.

One particularly desirable manufacturing method includes solely the dry blending of the selected ingredients to form a dry blended powder; that is, all of the ingredients present are dryblended together in dry form. In this process, for example, the cereal beta-glucan, Salacia extract, resistant starch, and filler material, and any other optional materials, each in dry form, are combined as such and thoroughly mixed in a suitable mixing apparatus to form a dry blended nutritional composition in powder form. The resulting dry blended composition may then be packaged in any desired size and material suitable for containing nutritional compositions in powder form.

The nutritional compositions may, of course, be manufactured by other known or otherwise suitable techniques not specifically described herein without departing from the spirit and scope of the present disclosure. For example, a base powder including one or more of the desired ingredients may be prepared using conventional spray drying techniques and all or a portion of the cereal beta-glucan and resistant starch dryblended into the base powder. The present embodiments are, therefore, to be considered in all respects as illustrative and not restrictive and all changes and equivalents also come within the description of the present disclosure.

### Methods of Use

The nutritional compositions described herein may be used in accordance with the methods of the present disclosure, wherein such methods comprise the oral administration of the nutritional compositions described herein to individuals in need of blood glucose control, especially for modulating the blood glucose response during and or after a meal, including a carbohydrate-containing meal.

In accordance with the methods described herein, the term blood glucose control means a delay in the peak blood glucose response following a meal, a reduced blood glucose peak level following a meal, and/or a reduced blood glucose AUC following a meal.

The methods are especially useful in individuals afflicted with prediabetes, individuals afflicted with type 2 diabetes, overweight or obese individuals, individuals with impaired glucose tolerance, individuals at risk for developing diabetes, or other individuals who may otherwise benefit from the blood glucose control benefits made possible by the methods and compositions described herein.

In accordance with the methods described herein, the nutritional compositions may be administered to, or orally consumed by, an individual before, during, or after a meal to control blood glucose levels as defined herein.

In one embodiment of the methods described herein, the nutritional product in powder form is reconstituted water, including cold water, tea or other suitable liquid and then orally consumed by an individual before, during, or after a meal. The reconstitution can be done in any suitable container including, for example, a tumbler, shaker, bottle, and the like.

In another embodiment of the methods described herein, the nutritional product in powder form is sprinkled on food before it is consumed such that the nutritional composition in powder form is ingested during the meal.

The nutritional compositions may be administered to or consumed by the individual with one or more carbohydrate-containing or other meals per day, and or may be administered to or consumed by the individual once daily, twice daily, three times a day, four times a day or even more times per day to provide the desired blood control in the individual. The nutritional composition may be administered to or consumed by the individual within 0 to 60 minutes of the meal, including within 1 to 30 minutes of the meal, and including during the meal.

### EXAMPLES

The following Examples illustrate specific embodiments and or features of the nutritional compositions and methods of the present disclosure. The Examples are given solely for the purpose of illustration and are not to be construed as limitations, as many variations thereof are possible without departing from the spirit and scope of the disclosure.

### Example 1

In this Example, various methods were evaluated for improving the dispersibility of barley beta-glucan in water.

The first method for improving dispersibility was dry blending the barley beta-glucan with one of ten different excipients listed in the table below. Particularly, the barley beta-glucan Barliv™ (commercially available from Cargill Europe BVBA, Belgium) was separately dry-blended with each excipient in a ratio of Barliv:excipient of 1:2. The resulting powder mixture was then added to 150 ml room temperature water and evaluated for dispersibility.

| Sample | Excipient | Common Name |
|---|---|---|
| 1 | Maltrin ® M040 (Prinova ™, | Maltodextrin |
| | Carol Stream, Illinois) | |
| 2 | Maltrin ® QD40 | Maltodextrin in agglomerated |
| | (Prinova ™, Carol Stream, | form |
| | Illinois) | |
| 3 | Orafti P95 (Beneo Orafti, | Fructo-oligosaccharides |
| | Belgium) | (FOS) |
| 4 | Fructose | Fructose |
| 5 | Nutriose ® (Roquette, | Wheat dextrose |
| | France) | |
| 6 | Sun Fibre (Japan) | Partially hydrolyzed guar gum |
| 7 | Fibersol ®-2 (ADM, | Resistant starch |
| | Decatur, Illinois) | |
| 8 | Orafti Synergy 1 (Beneo | Inulin and FOS |
| | Orafti, Belgium) | |
| 9 | Lactose | Lactose |
| 10 | Litesse ® (Danisco, | Polydextrose |
| | Denmark) | |

A second method using agglomeration or wet granulation methods was evaluated using NIRO Strea-1 Pro fluidized bed granulation (available from National University of Singapore). Barliv™ was agglomerated with one of lecithin, maltodextrin, or maltodextrin/monoglycerides combination as shown in the table below. Once agglomerated, the agglomerated powders were added to 150 ml room temperature water and evaluated.

| Sample | Agglomerated Powder |
|---|---|
| 11 | Barliv ™ + 0.5% lecithin |
| 12 | Barliv ™ + 2% lecithin |
| 13 | Barliv ™ + 4% lecithin |
| 14 | Barliv ™ + 7% maltodextrin (DE4) at |
| | particle size of <600 pm |
| 15 | Barliv ™ + 7% maltodextrin (DE4) at |
| | particle size of >600 pm |
| 16 | Barliv ™ + 3% maltodextrin (DE4) + |
| | 0.8% monoglycerides |
| 17 | Barliv ™ + 5% maltodextrin (DE4) + |
| | 1.3% monoglycerides |

A third method for improving dispersibility included dry compaction/granulation of Barliv™, which was intended to slow water adsorption. Barliv™ was compacted at different roller pressures (Sample 18—80 KN, Sample 19—100 KN, and Sample 20—120 KN). Flakes obtained from compaction were then subsequently milled down by passing through a screen size of 447 μm. The compacted/milled Barliv™ was then introduced into 150 ml room temperature water and evaluated.

A final method evaluated for improving dispersibility included mixing and coating Barliv™ with one of (Sample 21) hydrogenated cottonseed oil, (Sample 22) hydrogenated vegetable oil or (Sample 23) glyceryl monostearate at 2% w/w using a high shear mixer set at the speed of 250 rpm. The coated samples were dissolved in 150 ml room temperature water and evaluated.

All evaluations included stirring the samples in the room temperature water for a period of approximately 30 seconds. Good dispersibility is defined as complete dispersion of powder with no powder sticking and formulate of lumps observed. The dispersibility results are shown in the table below.

| Method | Sample | Ingredient | Observation |
|---|---|---|---|
| Dry-blending | 1 | Barliv ™: Maltrin ® | Poor |
| | | M040 | dispersibility. |
| | | | Lumps settled at |
| | | | the bottom. |
| | 2 | Barliv ™: Agglomerated | Poor |
| | | Maltrin ® QD40 | dispersibility. |
| | | | Lumps settled at |
| | | | the bottom. |
| | 3 | Barliv ™: Orafti P95 | Poor |
| | | | dispersibility. |
| | | | Lumps settled at |
| | | | the bottom. |
| | 4 | Barliv ™: Fructose | Improved |
| | | | dispersibility. |
| | | | Some small |
| | | | lumps observed |
| | | | at the bottom. |
| | 5 | Barliv ™: Nutriose ® | Good and |
| | | | complete |
| | | | dispersibility in |
| | | | water. No lumps |
| | | | were seen. |
| | 6 | Barliv ™: Sun Fibre | Very poor |
| | | | dispersibility. Big |
| | | | lumps observed at |
| | | | the bottom. |
| | 7 | Barliv ™: Fibersol ® | Very poor |
| | | | dispersibility. Big |
| | | | lumps floating on |
| | | | top and at the |
| | | | bottom. |
| | 8 | Barliv ™: Orafti Synergy | Improvement on |
| | | 1 | dispersibility. |
| | | | Small lumps still |
| | | | observed at the |
| | | | bottom. |
| | 9 | Barliv ™: Lactose | Very poor |
| | | | dispersibility. Big |
| | | | lumps settled at |
| | | | the bottom. |
| | 10 | Barliv ™: Litesse | Slight |
| | | | improvement on |
| | | | dispersibility. |
| | | | Some lumps still |
| | | | observed at the |
| | | | bottom. |
| Agglomeration | 11 | Barliv ™ + 0.5% lecithin | Slight |
| | | | improvement on |
| | | | dispersibility. |
| | | | Some lumps still |
| | | | present. |
| | 12 | Barliv ™ + 2% lecithin | Slight |
| | | | improvement on |
| | | | dispersibility. |
| | | | Some lumps still |
| | | | present. |
| | 13 | Barliv ™ + 4% lecithin | Slight |
| | | | improvement on |
| | | | dispersibility. |
| | | | Some lumps still |
| | | | present. |
| Dry | 18-20 | Barliv ™ roller-pressed | Improvement in |
| compaction/ | | at 80, 100 and 120 KN | dispersibility |
| Granulation | | | observed in |
| | | | Barliv ™passed |
| | | | through higher |
| | | | roller pressure at |
| | | | 120 KN. Some |
| | | | lumps were still |
| | | | present. |
| Coating with | 21 | Barliv ™ + 2% | Very poor |
| hydrophobic | | hydrogenated cottonseed | dispersibility. |
| materials | | oil | Lumps floating |
| | | | on top of |
| | | | dispersion. |
| | 22 | Barliv ™ + 2% | Very poor |
| | | hydrogenated vegetable | dispersibility. |
| | | oil | Lumps floating |
| | | | on top of |
| | | | dispersion. |
| | 23 | Barliv ™ + 2% glyceryl | Some |
| | | monostearate | improvement on |
| | | | dispersibility, but |
| | | | still small lumps |
| | | | present. |

As shown in the above table, only the dry-blending of Barliv™ with Nutriose® at a ratio of 1:2 (Barliv™:Nutriose®) was able to completely overcome the dispersibility, wettability, and solubility issue. At the ratio of 1:2, the powder mixture was found to be completely dispersed well in water with no lumps observed after the 30 seconds of stirring. It is believed that the improved dispersibility is most likely attributed to the excellent solubility and agglomerated physical form of Nutriose®. These attributes allow the fine particles of Barliv™ to remain separate and reduce lumping.

### Examples 2-4

In the following Examples, exemplary ready-to-drink powders of the present disclosure are shown. All Examples are 100% dryblended ready-to-drink powders.

| Ingredient | Example 2 | | Example 3 | | Example 4 | |
|---|---|---|---|---|---|---|
| Salacia extract (g) | 0.18 | | 0.18 | | 0.18 | |
| Barliv ™ (g) | 1.1 | | 1.1 | | 1.1 | |
| Nutriose ® (g) | 6.0 | | 6.0 | | 6.0 | |
| FOS (g) | 1.52 | | 0.81 | | 0.86 | |
| Fructose (g) | 1.0 | | 1.0 | | 1.0 | |
| Flavor Agent (g) | — | | 0.4 | | 0.304 | |
| Citric acid (g) | — | | 0.3 | | 0.3 | |
| Tricalcium | 0.1 | | 0.1 | | 0.1 | |
| phosphate (g) | | | | | | |
| Xanthan gum (g) | 0.1 | | 0.1 | | 0.1 | |
| Sucralose (g) | — | | 0.01 | | 0.01 | |
| Total (g) | ~10 | g | ~10 | g | ~10 | g |

### Example 5

In this Example, the effect of various water-soluble dietary fibers (Sunfibre®, Nutriose®, WPG™ Yeast Beta-Glucan and Barliv™), alone or in combination with Salacinol (Salacia oblonga extract D), on postprandial glucose levels at 30 minutes are analyzed. Pre-diabetic (obese rats) and diabetic animal models are evaluated.

Postprandial blood glucose levels are evaluated in the prediabetic (obese) and diabetic Zucker male rats and in diabetic male mice at the age of approximately 6-8 weeks. Initially, the body weights of the animals are recorded before fasting and basal blood glucose measurements are taken. The animals fast overnight and are then randomized based on their basal glucose levels and assigned into different experimental groups (n=5 to 7 per group).

Various sample compositions of water-soluble fibers and or Salacinol are prepared. To formulate the sample compositions, a corn starch suspension is first prepared by mixing 1 gram of corn starch with 10 ml of 0.5% Tween-80 in distilled water. The water-soluble fiber and or Salacinol are then slowly added to and mixed with the corn starch suspension at the concentrations described in the following table.

| Sample | | | | | |
|---|---|---|---|---|---|
| (mg/ | | | | | |
| Kg) | Sunfibre ® | Nutriose ® | Barliv ™ | WPG ™ | Salacinol |
| 1 | 600 | — | — | | — |
| 2 | 600 | — | — | | 12.5 |
| 3 | 1000 | — | — | | — |
| 4 | 1000 | — | — | | 12.5 |
| 5 | — | 100 | — | | — |
| 6 | — | 100 | — | | 6.25 |
| 7 | — | — | 100 | | — |
| 8 | — | — | 100 | | 6.25 |
| 9 | — | — | 200 | | — |
| 10 | — | — | 200 | | 12.5 |
| 11 | — | — | — | | 6.25 |
| 12 | — | — | — | | 12.5 |
| 13 | — | — | — | — | 6.25 |
| 14 | — | — | — | 100 | 6.25 |

The compositions summarized above in the Table are administered to the animals (where mg/kg of sample refers to mg of fiber or Salacinol per kg of body weight of the animals) as a single oral dose (10 ml/Kg body weight) to the animals. After 30 minutes, the blood-glucose levels of the animals are tested using a glucometer and test strips (One Touch Ultra Lifescan, available from Johnson & Johnson, San Jose, Calif.). The tail of each animal is wiped clean with absorbent cotton and a drop of blood is obtained from the tip. Each sample of blood is placed on a sampling area of the glucometer strip.

Results are expressed as means+SEM as percent change in glucose (mg/dl). Statistical analysis is performed by t-test for blood glucose levels. The results are shown in the following table.

| | | Diabetic | | | Diabetic | Diabetic | | Diabetic |
|---|---|---|---|---|---|---|---|---|
| | Obese Rat | Rat | Obese Rat | Obese Rat | Rat | Rat | Obese Rat | Mouse |
| | Dosage (mg/Kg) | | | | | | | |
| | Sunfiber ® | Sunfiber ® | Nutriose ® | Barliv ™ | Barliv ™ | WPG ™ | Barliv ™ | Barliv ™ |
| | 600 | 1000 | 100 | 100 | 100 | 100 | 200 | 200 |
| | Saliconol | Saliconol | Salacinol | Salacinol | Salacinol | Salacinol | Salacinol | Salacinol |
| | 12.5 | 12.5 | 6.25 | 6.25 | 6.25 | 6.25 | 12.5 | 12.5 |
| Sunfibre ® | 27.4 | 37.5 | — | — | — | — | — | — |
| Nutriose ® | — | — | −1.80 | — | — | — | — | — |
| Barliv ™ | — | — | — | −6.1 | 1.3 | — | 2.7 | −17.5 |
| WPG ™ | — | — | — | — | — | −4.87 | — | — |
| Salacinol | −51.1 | −59.5 | −22.75 | −9.8 | 3.8 | −10.12 | −12.2 | −11.1 |
| Sunfibre ® + | −27.1 | −27.5 | — | — | — | — | — | — |
| Salacinol | | | | | | | | |
| Nutriose ® + | — | — | −19.41 | — | — | — | — | — |
| Salacinol | | | | | | | | |
| Barliv ™ + | — | — | — | −27.6 | −11.3 | — | −21.2 | −70.4 |
| Salacinol | | | | | | | | |
| WPG ™ + | — | — | — | — | — | −9.55 | — | — |
| Salacinol | | | | | | | | |
| Observed | Inhibition | Inhibition | No | Synergy | Synergy | No | Synergy | Synergy |
| Effect | | | synergy | | | synergy | | |

In the diabetic rat, obese rat, and diabetic mouse models, the combination of Barliv™ and Salacinol at varied concentrations shows significant synergistic activity in reducing postprandial glucose levels at 30 minutes. Sunfibre® shows significant inhibition of Salacinol activity on postprandial levels at all concentrations tested. Nutriose®, alone or in combination with Salacinol, does not show a significant effect on postprandial glucose levels. Additionally, the yeast derived beta-glucan (WPG™ Beta Glucan) in combination with the Salacinol showed a neutral, non-synergistic effect.

Based on these animal study results, the combination of Barliv™ (a cereal-based beta-glucan) and Salacinol produces a synergistic effect on postprandial glucose levels as compared to an inhibitory effect or no effect at all for the other fibers in combination with Salacinol.

### Example 6

In this Example, blood glucose lowering effects of barley-derived beta-glucan (Barliv™) and yeast-derived beta-glucan (WGP™) in pre-diabetic (obese) and diabetic animal models are compared. The effects are evaluated at postprandial time points of 30 minutes, 60 minutes, 90 minutes, and 120 minutes.

The effect on postprandial blood glucose levels is evaluated in obese and diabetic Zucker male rats and in diabetic male mice at the age of approximately 6-8 weeks. Initially, the body weights of the animals are recorded before fasting and before basal glucose measurements. The animals fast overnight and are then randomized based on their basal glucose level and assigned into 3 different experimental groups (n=9 per group).

A corn starch suspension is prepared by mixing 1 gram of corn starch with 10 ml of 0.5% Tween-80 in distilled water. This corn starch suspension is administered to the control group. A second suspension is prepared using the corn starch suspension prepared in the control group and slowly mixing Barliv™ (100 mg/Kg) therein. Additionally, a third suspension is prepared by slowly mixing the corn starch suspension of the control group with yeast whole beta-glucan particle (WGP™) (100 mg/Kg).

The compositions are administered to their respective experimental group at a single oral dosage (10 ml/Kg body weight) to the animals. After 30 minutes, 60 minutes, 90 minutes, and 120 minutes, the blood-glucose levels of the animals are tested using a glucometer and test strips (One Touch Ultra Lifescan, available from Johnson & Johnson). The tail of each animal is wiped clean with absorbent cotton and a drop of blood is obtained from the tip and placed on the sampling area of the glucometer strip.

Results are expressed as % change in AUC±SEM. Statistical analysis is performed by t-test for blood glucose levels and one-way ANOVA followed by Dunnett's multiple comparison for AUC using graph pad prism software (significance at P<0.05). The AUC (0-120 min) values expressed as percent change in blood glucose level are shown in the following table.

| | % change in AUC (0-120 min) |
|---|---|
| Cornstarch Control Group | 0 |
| Barliv ™ Group | −18.1% |
| WCP ™ Group | 3.9% |

The administration of Barliv™ with the corn starch solution shows a significant glucose lowering effect in the mice as compared to the administration of WGP™ in the same animal model. The data further shows that WGP™ does not lower blood glucose levels at all.

What is claimed is:

1. A powdered nutritional composition comprising a dryblended mixture of a neat cereal beta-glucan and a resistant starch.

2. The powdered nutritional composition of claim 1 wherein 100% by weight of the cereal beta-glucan and 100% by weight of the resistant starch present in the nutritional composition is in dryblended form.

3. The powdered nutritional composition of claim 1 wherein the cereal beta-glucan and resistant starch are present in a weight ratio of from about 1:1 to about 1:10.

4. The powdered nutritional composition of claim 1 wherein the cereal beta-glucan and resistant starch are present in a weight ratio of from about 1:1 to about 1:5.5.

5. The powdered nutritional composition of claim 1 wherein the cereal beta-glucan is selected from the group consisting of oat beta-glucan, barley beta-glucan, and combinations thereof.

6. The powdered nutritional composition of claim 1 wherein the resistant starch is selected from the group consisting of resistant starch derived from wheat, resistant starch derived from corn, and combinations thereof.

7. The powdered nutritional composition of claim 6 wherein the resistant starch is in agglomerated form.

8. The powdered nutritional composition of claim 7 wherein the dryblended mixture comprises a barley beta-glucan and a resistant starch derived from wheat.

9. The powdered nutritional composition of claim 1 wherein the powdered composition further includes a Salacia extract.

10. The powdered nutritional composition of claim 9 wherein the Salacia extract is selected from the group consisting of Salacia oblonga extract, Salacia reticula extract, and combinations thereof.

11. The powdered nutritional composition of claim 10 further comprising fructooligosaccharide and fructose.

12. The powdered nutritional composition of claim 11 further comprising tricalcium phosphate, xanthan gum, and sucralose.

13. A powdered nutritional composition including 100% by weight dryblended components, the components including a neat cereal beta-glucan, a resistant starch, a Salacia extract and fructooligosaccharides.

14. The powdered nutritional composition of claim 13 wherein the resistant starch is derived from wheat.

15. The powdered nutritional composition of claim 14 wherein the resistant starch derived from wheat is in agglomerated form.

16. The powdered nutritional composition of claim 15 further comprising fructose, citric acid, tricalcium phosphate, xanthan gum, and sucralose.

17. A method of improving the cold water solubility of a powdered nutritional composition comprising a neat cereal beta-glucan, the method comprising dryblending the cereal beta-glucan with a resistant starch.

18. The method of claim 17 wherein 100% by weight of the cereal beta-glucan and 100% by weight of the resistant starch present in the nutritional composition is in dryblended form.

19. The method of claim 17 wherein the cereal beta-glucan is selected from the group consisting of oat beta-glucan, barley beta-glucan, and combinations thereof.

20. The method of claim 17 wherein the resistant starch is selected from the group consisting of a resistant starch derived from wheat, a resistant starch derived from corn, and combinations thereof.

21. The method of claim 17 wherein the nutritional composition further comprises a Salacia extract selected from the group consisting of Salacia oblonga extract, Salacia reticula extract, and combinations thereof.
